(19) United States
(12) Patent Application Publication
(10) Pub. No.: US 2024/0241812 A1
(43) Pub. Date: Jul. 18, 2024

(54) SYSTEM AND METHOD FOR COMPUTING RESULTS IN MULTIPLE OVERLAPPING A/B TESTING EXPERIMENTS

(71) Applicant: CONVERTCART SOLUTIONS PRIVATE LIMITED, Bangalore (IN)

(72) Inventor: SURESH RAO, BENGALURU (IN)

(21) Appl. No.: 18/412,072

(22) Filed: Jan. 12, 2024

(30) Foreign Application Priority Data
Jan. 16, 2023 (IN) 202241040808

(51) Int. Cl. G06F 11/36

(52) U.S. Cl. CPC G06F 11/3664; G06F 11/3688; G06F 11/3696

(57) ABSTRACT

The present invention discloses a system and a method for correcting overlapping issues in A/B testing experiments. The system is configured to allocate a plurality of control versions of a webpage to a plurality of control groups and a plurality of experimental versions of a webpage to a plurality of experimental groups. The system is further configured to calculate a first experiment gain for each of the plurality of experimental versions of the webpage based on a number of users identified for carrying out an interaction in the each of the plurality of experimental versions of the webpage. The system is configured to calculate a second experiment gain for each of the plurality of experimental versions of the webpage using a modified number of interactions. Further, the system is configured to calculate a final gain based on the first experiment gain and the second experiment gain.

### FIELD OF INVENTION

The present invention relates to a field of set theory. More specifically, the present invention relates to a system and method for improving processes and reducing or correcting overlapping issues while performing A/B testing experiments.

### BACKGROUND OF INVENTION

Today, A/B testing is being used by data engineers, marketers, designers, software engineers, and entrepreneurs, for conducting complex experiments on subjects such as network effects when users are offline, how online services affect user actions, and how users influence one another. Many companies rely on data received from A/B testing, as they allow companies to understand growth, increase revenue, and optimize customer satisfaction. A/B testing is considered one of the finest tools by the companies as the A/B testing helps to demonstrate the efficacy of potential changes, prove how changes can impact conversions, enable data-driven decisions, and ensure positive impacts.

A/B Testing (also known as split testing) is a method used for comparing two versions of a webpage or an app against each other to determine which one performs better. A/B testing is essentially an experiment where two or more variants of a webpage or an app are shown to multiple users at random, and statistical analysis is used to determine which variation of the webpage or the app performs better for a given conversion goal and drives business metrics.

In A/B Testing, multiple users are selected at random and divided into two groups—a control group and an experiment group. A control group is a variant where a group of users receive an original version of a webpage or an app. An experiment group is a variant where a group of users receive a modified version of a webpage or an app. A modified version of a webpage or an app may include changes such as a change in a single headline or a button or a complete redesign of the page. The group of users in an experiment group gets exposed to changes carried out on a webpage to test whether there is a statistically significant difference in comparison with the control group or the other variants of the experiment group.

Once the users are divided into the control group and the experiment group, the users in the control group are shown original version of the webpage or app and the users of the experiment group are shown modified version of the webpage or app. Thereafter, the engagement of the users with each experience is measured and analysed through a statistical engine which in turn determines whether changing the experience had a positive, negative, or neutral effect on a user behaviour.

In an ideal scenario, companies run multiple experiments simultaneously on a website or app to test a solution to one or more problem(s). However, the control and experiment groups routinely overlap between the experiments which result in inaccurate measurement of gains. It also affects the conversion rates of experiment and control groups. Additionally, it is also not possible to estimate the cumulative gain obtained for a website or app. The existing A/B testing techniques used by companies neglect such overlapping issues due to which a precise gain is not calculated for individual experiments.

Further, overlapping issues may be handled by performing mutually exclusive experiments, wherein exclusive groups are created by splitting number of users into different groups to avoid overlap and perform the experiment independently. This can only be experimented on websites with millions of users, however, exclusive experiments for a small number of users may not be feasible for A/B testing.

Furthermore, to run any experiment maximum time recommended is generally two months. If a group size is too small, then the experiment cannot be completed within two months period, thereby leading to inefficient and time-consuming experiment testing. Also, an experiment requires an adequate number of users to achieve an expected statistical significance within two months period. If the sample size is small, then the number of users in a month for the experiment will be small. As a result, it may not be possible to conclude the experiment. Therefore, to acquire the required number of users the experiment will exceed the two-month period which in turn is not beneficial to serve the purpose of the scheduled experiment. The standard limit to run the experiment is two months because after two months behaviour of a website or rules may change which can affect the uniformity of the users of the scheduled experiment.

In order to overcome the above problem, overlapping issues may be avoided by performing sequential execution of experiments, wherein the experiments are executed serially one after another to avoid the overlap. However, such an approach may be time-consuming and not efficient for running multiple experiments in parallel.

Therefore, there is a need for a system and a method for correcting overlapping issues in A/B testing experiments. There is also a need for a system and a method for estimating a cumulative gain obtained for a website by correcting overlapping issues. Further, there is a need for a system and a method for calculating a gain of an experiment run simultaneously with other experiments. Also, there is a need for a system and a method for estimating correct gains of experiments within suggested time frame.

### OBJECT OF INVENTION

The object of the present invention is to provide a system and a method for correcting overlapping issues in A/B testing experiments. The object of the present invention is to provide a system and a method for estimating a cumulative gain obtained for a website by correcting overlapping issues. Further, the object of the present invention is to provide a system and a method for calculating a gain of an experiment run simultaneously with other experiments and obtaining precise gain for each experiment individually.

### SUMMARY

The present application discloses a system for correcting overlapping issues in A/B testing experiments. The system includes a data receiving unit configured to receive a plurality of control versions of a webpage and a plurality of experimental versions of the webpage. The system further includes a user allocation unit configured to allocate users into a plurality of control groups and a plurality of experiment groups.

Further, the system includes a data allocation unit configured to allocate the plurality of control versions of the webpage to the plurality of control groups and the plurality of experimental versions of the webpage to the plurality of experimental groups. The data allocation unit allocates one experimental version of the webpage to one respective experimental group and one control version of the webpage to one respective control group. The plurality of control versions of the webpage comprise original versions of the webpage and the plurality of experimental versions of the webpage comprise a change in the webpage compared to the original version of the webpage.

Furthermore, the system includes a data tracker unit configured to capture relevant data points from each of the plurality of experimental versions of the webpage and each of the control versions of the webpage, and to identify identity of users accessing each of the plurality of experimental versions of the webpage and each of the plurality of control versions of the webpage. The data tracker unit is further configured to identify number of users carrying out an interaction in each of the plurality of experimental versions of the webpage and each of the plurality of control versions of the webpage, and to calculate a first number of interactions carried out by each of the plurality of experiment groups and each of the plurality of control groups based on the interactions carried out by the users identified for each of the plurality of experiment groups and each of the plurality of control groups.

Also, the system includes a first experiment gain calculator unit configured to calculate a first experiment gain for each of the plurality of experimental versions of the webpage based on the number of users identified for carrying out an interaction in the each of the plurality of experimental versions of the webpage. The system includes an experiment overlap calculator unit configured to identify users common in the plurality of experiment groups and the plurality of control groups and to calculate interactions carried out by the identified common users in each of the plurality of experiment groups and each of the plurality of control groups to generate overlapping experiment groups and experiment groups overlapping with the control groups.

The system includes an additional interaction estimator unit configured to calculate additional number of interactions carried out by each of the identified common users using gain data from the overlapping experiment groups and experiment groups overlapping with the control groups. The system further includes an interaction data updater unit configured to obtain modified number of interactions by subtracting the additional number of interactions from the first number of interactions calculated for each of the plurality of experimental versions of the webpage and each of the plurality of control versions of the webpage.

Further, the system includes a second experiment gain calculator unit configured to calculate a second experiment gain for each of the plurality of experimental versions of the webpage using the modified number of interactions. The system includes a gain difference calculator unit configured to calculate difference between the first gain and the second gain. Also, the system includes a gain comparison unit configured to compare the calculated gain difference with a predefined threshold. The gain comparison unit sends each of the plurality of experimental versions of the webpage and each of the plurality of control versions of the webpage to the data tracker unit for which the calculated gain difference is more than the predefined threshold. The system also includes a final experiment gain calculator unit configured to record a final gain for each of the plurality of experimental versions of the webpage when the calculated gain difference is less than the predefined threshold.

The present disclosure further discloses a method for correcting overlapping issues in A/B testing experiments. The method includes receiving, by a data receiving unit, a plurality of control versions of a webpage and a plurality of experimental versions of the webpage. The method further includes allocating, by a user allocation unit, users into a plurality of control groups and a plurality of experiment groups. The method includes allocating, by a data allocation unit, the plurality of control versions of the webpage to the plurality of control groups and the plurality of experimental versions of the webpage to the plurality of experimental groups, wherein one experimental version of the webpage is allocated to one respective experimental and one control version of the webpage is allocated to one respective control group.

Further, the method includes capturing, by a data tracker unit, relevant data points from each of the plurality of experimental versions of the webpage and each of the control versions of the webpage. The method includes identifying, by the data tracker unit, identity of users accessing each of the plurality of experimental versions of the webpage and each of the plurality of control versions of the webpage. The method includes identifying, by the data tracker unit, number of users carrying out an interaction in each of the plurality of experimental versions of the webpage and each of the plurality of control versions of the webpage.

Furthermore, the method includes calculating, by the data tracker unit, a first number of interactions carried out by each of the plurality of experiment groups and each of the plurality of control groups based on the interactions carried out by the users identified for each of the plurality of experiment groups and each of the plurality of control groups. The method includes calculating, by a first experiment gain calculator unit, a first experiment gain for each of the plurality of experimental versions of the webpage based on the number of users identified for carrying out an interaction in the each of the plurality of experimental versions of the webpage. Also, the method includes identifying, by an experiment overlap calculator unit, users common in the plurality of experiment groups and the plurality of control groups and to calculate interactions carried out by the identified common users in each of the plurality of experiment groups and each of the plurality of control groups to generate overlapping experiment groups and experiment groups overlapping with the control groups.

The method includes calculating, by an additional interaction estimator unit, additional number of interactions carried out by each of the identified common users using gain data from the overlapping experiment groups and experiment groups overlapping with the control groups. The method includes obtaining, by an interaction data updater unit, modified number of interactions by subtracting the additional number of interactions from the first number of interactions calculated for each of the plurality of experimental versions of the webpage and each of the plurality of control versions of the webpage.

Further, the method includes calculating, by a second experiment gain calculator unit, a second experiment gain for each of the plurality of experimental versions of the webpage using the modified number of interactions. The method includes calculating, by a gain difference calculator unit, difference between the first gain and the second gain. The method includes comparing, by a gain comparison unit, the calculated gain difference with a predefined threshold. Also, the method includes sending each of the plurality of experimental versions of the webpage and each of the plurality of control versions of the webpage to the data tracker unit for which the calculated gain difference is more than the predefined threshold, and repeating the steps. The method further includes recording, by a final experiment gain calculator unit, a final gain for each of the plurality of experimental versions of the webpage when the calculated gain difference is less than the predefined threshold.

### BRIEF DESCRIPTION OF DRAWINGS

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 illustrates an exemplary scenario 100 of overlapping experiments, in accordance with an embodiment of the present disclosure.

FIG. 2 illustrates a system 200 for correcting overlapping issues in A/B testing experiments, in accordance with an embodiment of the present disclosure.

FIG. 3 illustrates a method 300 for correcting overlapping issues in A/B testing experiments, in accordance with an embodiment of the present disclosure.

The figures depict embodiments of the disclosure for purposes of illustration only. One skilled in the art will readily recognize from the following description that alternative embodiments of the assemblies, structures and methods illustrated herein may be employed without departing from the principles of the disclosure described herein.

### DETAILED DESCRIPTION

The best and other modes for carrying out the present invention are presented in terms of the embodiments, herein depicted in drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced items.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

The system, methods, and examples provided herein are only illustrative and not intended to be limiting.

Embodiments of the present invention will be described below in detail with reference to the accompanying figures.

The present invention focusses on providing a system and a method for correcting overlapping issues in A/B testing experiments. A/B Testing (also known as split testing) is a method used for comparing two versions of a webpage or an app (hereinafter referred to as a webpage) against each other to determine which one performs better. A/B testing is essentially an experiment where two or more variants of a webpage are shown to multiple users at random, and statistical analysis is used to determine which variation of the webpage performs better for a given conversion goal and drives business metrics.

In A/B Testing, multiple users are selected at random and divided into two groups—a control group and an experiment group. A control group is a variant where a group of users receive an original version or a control version (hereinafter referred to as control version) of a webpage. An experiment group is a variant where a group of users receive a modified version or experimental version (hereinafter referred to experimental version) of a webpage. An experimental version of a webpage may include changes such as a change in a single headline or a button or a complete redesign of the page. The group of users in an experiment group gets exposed to changes carried out on a webpage to test whether there is a statistically significant difference in comparison with the control group or the other variants of the experiment group.

Once the users are divided into the control group and the experiment group, the users in the control group are shown a control version of the webpage and the users of the experiment group are shown an experimental version of the webpage. Thereafter, the engagement of the users with the experimental and control versions is measured and analysed through a statistical engine which in turn determines whether changing the webpage had a positive, negative, or neutral effect on a user behaviour.

In an ideal scenario, companies run multiple experiments simultaneously on a website to test a solution to one or more problem(s). However, the control and experiment groups routinely overlap between the experiments which result in inaccurate measurement of gains. It also affects the conversion rates of experiment and control groups. Additionally, it is also not possible to estimate the cumulative gain obtained for a website. The existing A/B testing techniques used by companies neglect such overlapping issues due to which a precise gain is not calculated for individual experiments. Further, overlapping issues may be handled by performing mutually exclusive experiments. However, mutually exclusive experiments can only be experimented on websites with millions of users, and not for a small number of users.

In order to overcome the above problem, overlapping issues may be avoided by performing sequential execution of experiments, wherein the experiments are executed serially one after another to avoid the overlap. However, such an approach may be time-consuming and not efficient for running multiple experiments in parallel.

Therefore, the present invention discloses a system and a method for correcting overlapping issues in A/B testing experiments. The present invention discloses a system and a method for estimating a cumulative gain obtained for a website by correcting overlapping issues. Further, the present invention discloses a system and a method for calculating a gain of an experiment run simultaneously with other experiments, and for estimating correct gains of experiments within suggested time frame.

The present invention discloses correcting overlapping issues in A/B testing experiments, where multiple experiments are performed simultaneously for a webpage. Let us consider a scenario where a company runs two experiments in parallel. The two experiments are run in parallel by allocating a first control version of the webpage to a first control group CG1 and first experimental version of the webpage to a first experimental group EG1. Similarly, a second control version of the webpage is allocated to a second control group CG2 and second experimental version of the webpage is allocated to a second experiment group EG2. When the two experiments are run together, there may be a case in which users carrying out interactions in the first experimental group EG1 may also be carrying out interactions in the second experimental group EG2 or any of the control groups CG1 and CG2. Therefore, when the two experiments are run together, there is an overlap caused by interactions carried out by such users who are part of more than one group. Therefore, the present invention provides a solution in correcting such overlapping caused by the users who are part of more than one group.

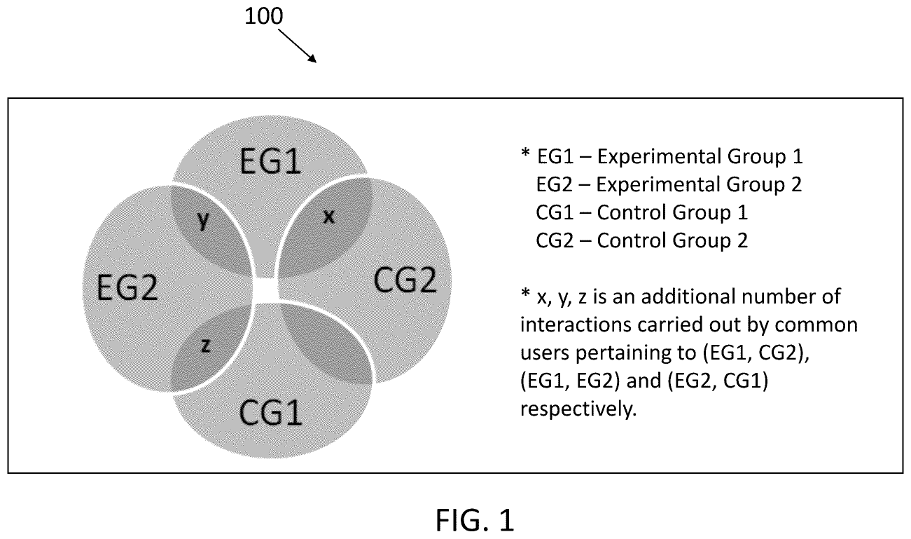

FIG. 1 illustrates an exemplary scenario 100 of overlapping experiments, in accordance with an embodiment of the present disclosure. As illustrated in FIG. 1, the overlapping is represented by x, y and z, where x represents interactions carried out by users common in the first experiment group EG1 and the second control group CG2, y represents interactions carried out by users common in the first experiment group EG1 and the second experiment group EG2, and z represents interactions carried out by users common in the second experiment group EG2 and the first control group CG1. As a result of such overlapping, conversion rate of experiment and control groups of one experiment is impacted by the other experiment and vice versa. Also, due to such overlaps, it is difficult to find an exact gain achieved by individual experiments.

Therefore, the present invention discloses removing deviations introduced by other experiments in both the experiment and control group of each experiment iteratively. The present invention discloses removing the overlapping interactions x, y, and z (as illustrated in FIG. 1); obtaining a new interaction count for each group experiment group EG1 and EG2 and each control group CG1 and CG2; and calculating a precise gain for each group EG1, EG2, CG1 and CG2 accordingly.

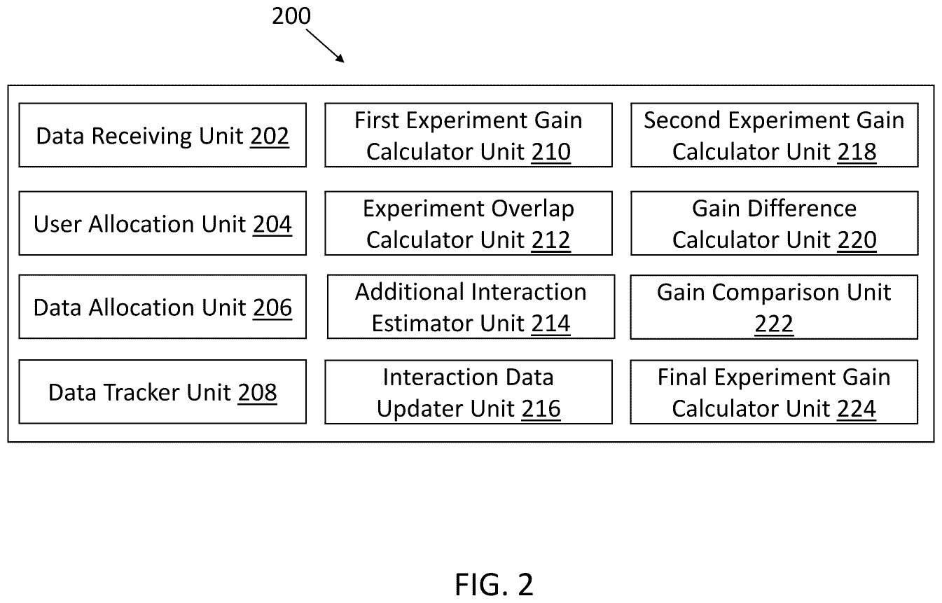

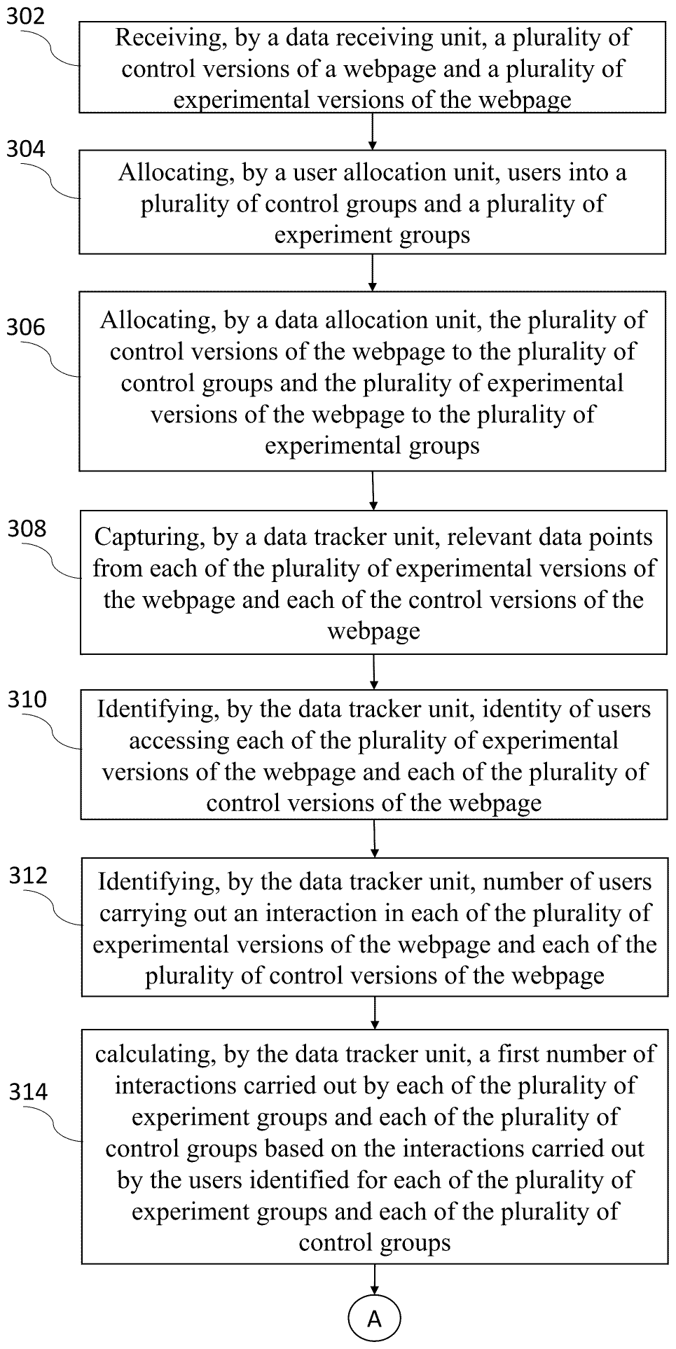

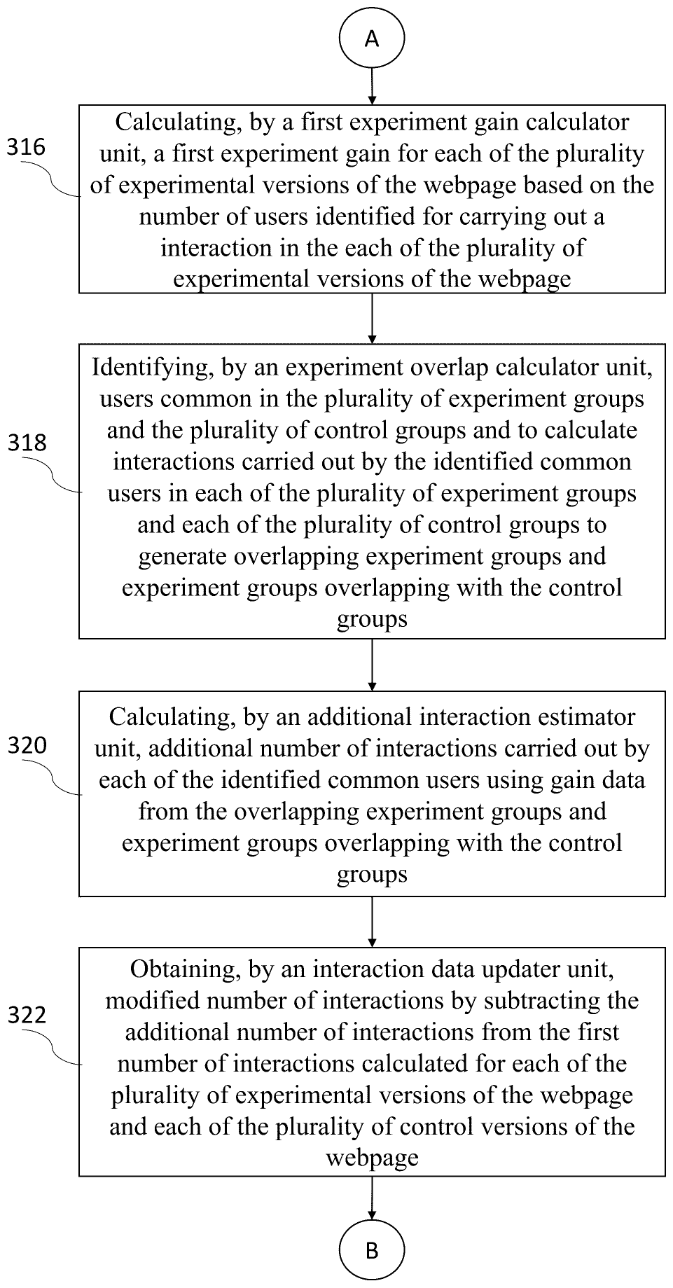

FIG. 2 illustrates a system 200 for correcting overlapping issues in A/B testing experiments, in accordance with an embodiment of the present disclosure. The system 200 is configured to correct overlapping issues in A/B experiments running in parallel. The system 200 includes a data receiving unit 202, a user allocation unit 204, a data allocation unit 206, a data tracker unit 208, a first experiment gain calculator unit 210, an experiment overlap calculator unit 212, an additional interaction estimator unit 214, an interaction data updater unit 216, a second experiment gain calculator unit 218, a gain difference calculator unit 220, a gain comparison unit 222 and a final experiment gain calculator unit 224.

The data receiving unit 202 is configured to receive a plurality of control versions of a webpage and a plurality of experimental versions of the webpage. The data receiving unit 202 may receive the plurality of control versions and the plurality of experimental versions of the webpage from a user device (not shown) monitored by an employee of a company carrying out the A/B experiments or a third party handling the A/B experiments. The plurality of control versions of the webpage includes original versions of the webpage. The plurality of experimental versions of the webpage may include, but not limited to, changes such as a change in a single headline or a button, a complete redesign of the webpage, or any other change in the webpage as compared to the control versions of the webpage.

The user allocation unit 204 is configured to allocate users into a plurality of control groups and a plurality of experiment groups. The user allocation unit 204 allocates users randomly into the plurality of control groups and the plurality of experiment groups.

The data allocation unit 206 is configured to allocate the plurality of control versions of the webpage to the plurality of control groups and the plurality of experimental versions of the webpage to the plurality of experimental groups. The data allocation unit 206 allocates one experimental version of the webpage to one respective experimental group and one control version of the webpage to one respective control group.

The data tracker unit 208 is configured to capture relevant data points from each of the plurality of experimental versions of the webpage and each of the control versions of the webpage. The relevant data points may include, but are not limited to, actions or interactions carried out by users on each of the plurality of experimental versions of the webpage and each of the plurality of control versions of the webpage, number of users who have performed a conversion action after seeing an experimental version of the webpage or a control version of the webpage, transactions carried out by users, etc. The conversion action performed by users is usually a quantifiable action capable of turning a prospective user into a paying user. The interactions or actions performed by users may include, but not limited to, clicking on areas of interest on a webpage, adding items of interest to a cart while browsing a webpage, downloading information/data from a webpage, clicking on links provided on a webpage, making payments, searching information on a webpage, or doing any other action on a webpage.

The data tracker unit 208 is further configured to identify identity of users accessing each of the plurality of experimental versions of the webpage and each of the control versions of the webpage. After identifying the identity of users, the data tracker unit 208 is configured to identify number of users carrying out an interaction in each of the plurality of experimental versions of the webpage and each of the control versions of the webpage. Thereafter, the data tracker unit 208 is configured to calculate a first number of interactions carried out by each of the plurality of experiment groups and each of the plurality of control groups based on the interactions carried out by the users identified for each of the plurality of experiment groups and each of the plurality of control groups.

The first experiment gain calculator unit 210 is configured to calculate a first experiment gain for each of the plurality of experimental versions of the webpage based on the number of users identified for carrying out an interaction in the each of the plurality of experimental versions of the webpage. The experiment gain calculated by the experiment gain calculator unit 210 for each of the plurality of experimental versions of the webpage is a measure of improvement obtained for each of the plurality of experimental versions of the webpage in comparison to each of the plurality of control versions of the webpage.

The experiment overlap calculator unit 212 is configured to identify users common in the plurality of experiment groups and the plurality of control groups and to calculate interactions carried out by the identified common users in each of the plurality of experiment groups and each of the plurality of control groups to generate overlapping experiment groups and experiment groups overlapping with the control groups. For example, referring to FIG. 1, let us assume that a user A is accessing an experimental version of a webpage of the experimental group EG1 and the experimental group EG2. Then, the experiment overlap calculator unit 212 identifies this user A and calculates interactions carried out by the identified user A in the experimental group EG1 and the experimental group EG2 to generate overlapping groups EG1 and EG2. Similarly, let us assume that the same user A is also accessing a control version of a webpage in control group CG2. Then, the experiment overlap calculator unit 212 identifies the user A and calculates interactions carried out by the user A in the experimental group EG1 and the control group CG2 to generate overlapping groups EG1 and CG2.

The additional interaction estimator unit 214 is configured to calculate additional number of interactions carried out by each of the identified common users using gain data from the overlapping experiment groups and experiment groups overlapping with the control groups. For example, as explained above, consider the user A identified by the experiment overlap calculator unit 212. After the experiment overlap calculator unit 212 has generated the overlapping groups EG1, EG2, and EG1, CG2, the additional interaction estimator unit 214 calculates the additional number of interactions x and y by using gain data from the overlapping groups EG1, EG2 and EG1, CG2.

The interaction data updater unit 216 is configured to obtain modified number of interactions by subtracting the additional number of interactions from the first number of interactions calculated for each of the plurality of experimental versions of the webpage and each of the plurality of control versions of the webpage.

The second experiment gain calculator unit 218 is configured to calculate a second experiment gain for each of the plurality of experimental versions of the webpage using the modified number of interactions.

The gain difference calculator unit 220 is configured to calculate difference between the first gain and the second gain.

The gain comparison unit 222 is configured to compare the calculated gain difference with a predefined threshold. If the calculated gain difference is greater than the predefined threshold, the gain comparison unit 222 sends each of the plurality of experimental versions of the webpage and each of the plurality of control versions of the webpage to the data tracker unit 208 and same processing is performed by the system 200 on each of the sent plurality of experimental versions of the webpage and each of the sent plurality of control versions of the webpage till calculated gain difference for each of the plurality of experimental versions of the webpage and each of the plurality of control versions of the webpage is less than the predefined threshold.

The final experiment gain calculator unit 224 is configured to record a final gain for each of the plurality of experimental versions of the webpage when the calculated gain difference is less than the predefined threshold.

In an example, let us consider that a fast-growing fashion store “ABC” wants to run two experiment on their online website, and wants to analyze the conversion rate of users for the two experiments. The owner of the store “ABC” runs an experiment by declaring a 50% discount to users on their purchase and another experiment where a user will get a free gift with their purchase. There may be scenario in which common users visit the 50% discount webpage as well as the free gift webpage. So, in such a scenario in order to get a precise conversion rate for the two separate experiments (50% discount and free gift), the system 200 of the present disclosure calculates precise gain for each of the experiments (50% discount and free gift) by correcting an overlap caused by the common users in the experiments (50% discount and free gift), while running both the experiment (50% discount and free gift) simultaneously.

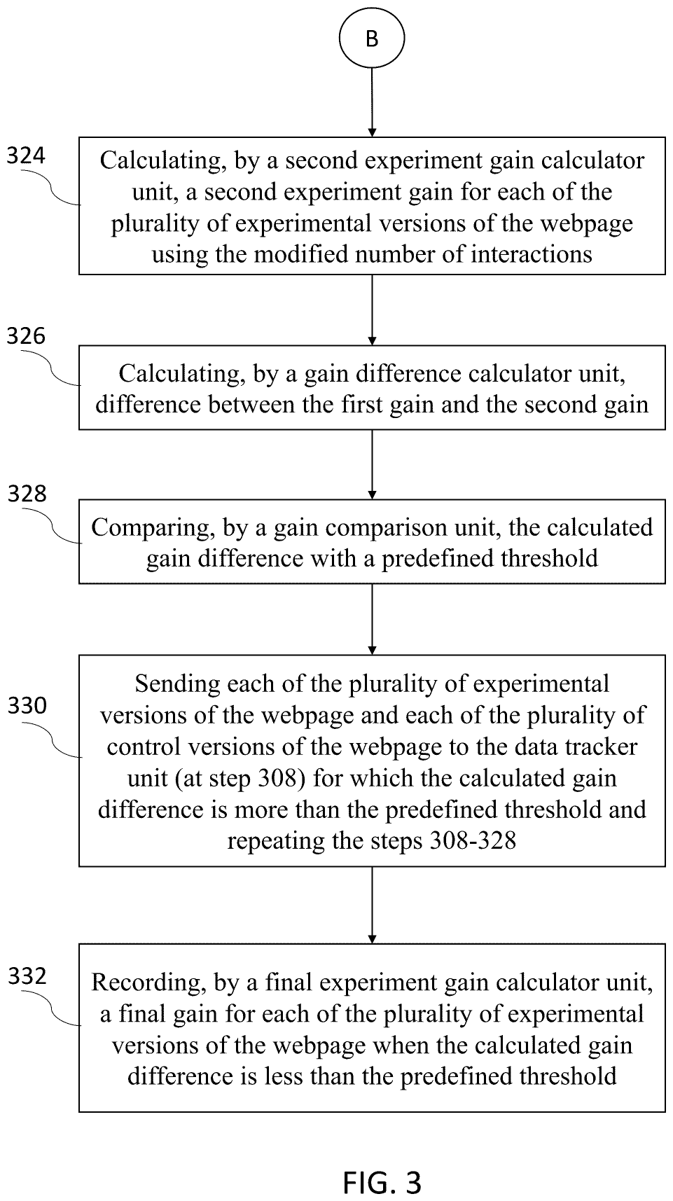

FIG. 3 illustrates a method 300 for correcting overlapping issues in A/B testing experiments, in accordance with an embodiment of the present disclosure. The step 302 includes receiving, by a data receiving unit 202, a plurality of control versions of a webpage and a plurality of experimental versions of the webpage. The step 304 includes allocating, by a user allocation unit 204, users into a plurality of control groups and a plurality of experiment groups.

The step 306 includes allocating, by a data allocation unit 206, the plurality of control versions of the webpage to the plurality of control groups and the plurality of experimental versions of the webpage to the plurality of experimental groups. The data allocation unit 206 allocates one experimental version of the webpage to one respective experimental and one control version of the webpage to one respective control group.

The step 308 includes capturing, by a data tracker unit 208, relevant data points from each of the plurality of experimental versions of the webpage and each of the control versions of the webpage. The step 310 includes identifying, by the data tracker unit 208, identity of users accessing each of the plurality of experimental versions of the webpage and each of the plurality of control versions of the webpage.

The step 312 includes identifying, by the data tracker unit 208, number of users carrying out an interaction in each of the plurality of experimental versions of the webpage and each of the plurality of control versions of the webpage.

The step 314 includes calculating, by the data tracker unit 208, a first number of interactions carried out by each of the plurality of experiment groups and each of the plurality of control groups based on the interactions carried out by the users identified for each of the plurality of experiment groups and each of the plurality of control groups.

The step 316 includes calculating, by a first experiment gain calculator unit 210, a first experiment gain for each of the plurality of experimental versions of the webpage based on the number of users identified for carrying out an interaction in the each of the plurality of experimental versions of the webpage.

The step 318 includes identifying, by an experiment overlap calculator unit 212, users common in the plurality of experiment groups and the plurality of control groups and to calculate interactions carried out by the identified common users in each of the plurality of experiment groups and each of the plurality of control groups to generate overlapping experiment groups and experiment groups overlapping with the control groups.

The step 320 includes calculating, by an additional interaction estimator unit 214, additional number of interactions carried out by each of the identified common users using gain data from the overlapping experiment groups and experiment groups overlapping with the control groups.

The step 322 includes obtaining, by an interaction data updater unit 216, modified number of interactions by subtracting the additional number of interactions from the first number of interactions calculated for each of the plurality of experimental versions of the webpage and each of the plurality of control versions of the webpage.

The step 324 includes calculating, by a second experiment gain calculator unit 218, a second experiment gain for each of the plurality of experimental versions of the webpage using the modified number of interactions.

The step 326 includes calculating, by a gain difference calculator unit 220, difference between the first gain and the second gain. The step 328 includes comparing, by a gain comparison unit 222, the calculated gain difference with a predefined threshold.

The step 330 includes sending each of the plurality of experimental versions of the webpage and each of the plurality of control versions of the webpage to the data tracker unit (at step 308) for which the calculated gain difference is more than the predefined threshold and repeating the steps 308-328. The step 332 includes recording, by a final experiment gain calculator unit 224, a final gain for each of the plurality of experimental versions of the webpage when the calculated gain difference is less than the predefined threshold.

The system and method for correcting overlapping issues in A/B testing experiments disclosed in the present disclosure have numerous advantages. The system and method for correcting overlapping issues in A/B testing experiments disclosed in the present disclosure addresses conversion accuracy of overlapping experiments in a prominent way without affecting simultaneous execution of experiments. The system and method for correcting overlapping issues in A/B testing experiments disclosed in the present disclosure estimates a cumulative gain obtained for a website by correcting overlapping issues. Further, the system and method for correcting overlapping issues in A/B testing experiments disclosed in the present disclosure calculates a gain of an experiment run simultaneously with other experiments and estimates correct gains of experiments within suggested time frame. Furthermore, the system and method for correcting overlapping issues in A/B testing experiments disclosed in the present disclosure determines whether experiment are a success or not based on conversion rate and gains calculated for the experiments. If an experiment group is converting better and shows a higher conversion rate than that of the control group, then the experiment is considered as successful.

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure.

It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

I/We claim:

1. A system (200) for correcting overlapping issues in A/B testing experiments, the system (200) comprising:
a data receiving unit (202) configured to receive a plurality of control versions of a webpage and a plurality of experimental versions of the webpage;
a user allocation unit (204) configured to allocate users into a plurality of control groups and a plurality of experiment groups;
a data allocation unit (206) configured to allocate the plurality of control versions of the webpage to the plurality of control groups and the plurality of experimental versions of the webpage to the plurality of experimental groups, wherein one experimental version of the webpage is allocated to one respective experimental group and one control version of the webpage is allocated to one respective control group;
a data tracker unit (208) configured to:
capture relevant data points from each of the plurality of experimental versions of the webpage and each of the control versions of the webpage;
identify identity of users accessing each of the plurality of experimental versions of the webpage and each of the plurality of control versions of the webpage;
identify number of users carrying out an interaction in each of the plurality of experimental versions of the webpage and each of the plurality of control versions of the webpage; and
calculate a first number of interactions carried out by each of the plurality of experiment groups and each of the plurality of control groups based on the interactions carried out by the users identified for each of the plurality of experiment groups and each of the plurality of control groups;
a first experiment gain calculator unit (210) configured to calculate a first experiment gain for each of the plurality of experimental versions of the webpage based on the number of users identified for carrying out an interaction in the each of the plurality of experimental versions of the webpage;
an experiment overlap calculator unit (212) configured to identify users common in the plurality of experiment groups and the plurality of control groups and to calculate interactions carried out by the identified common users in each of the plurality of experiment groups and each of the plurality of control groups to generate overlapping experiment groups and experiment groups overlapping with the control groups;
an additional interaction estimator unit (214) configured to calculate additional number of interactions carried out by each of the identified common users using gain data from the overlapping experiment groups and experiment groups overlapping with the control groups;
an interaction data updater unit (216) configured to obtain modified number of interactions by subtracting the additional number of interactions from the first number of interactions calculated for each of the plurality of experimental versions of the webpage and each of the plurality of control versions of the webpage;
a second experiment gain calculator unit (218) configured to calculate a second experiment gain for each of the plurality of experimental versions of the webpage using the modified number of interactions;
a gain difference calculator unit (220) configured to calculate difference between the first gain and the second gain;
a gain comparison unit (222) configured to compare the calculated gain difference with a predefined threshold; and
a final experiment gain calculator unit (224) configured to record a final gain for each of the plurality of experimental versions of the webpage when the calculated gain difference is less than the predefined threshold.

2. The system (200) as claimed in claim 1, wherein the plurality of control versions of the webpage comprises original versions of the webpage and the plurality of experimental versions of the webpage comprise a change in the webpage compared to the original version of the webpage.

3. The system (200) as claimed in claim 1, wherein the relevant data points comprise actions performed by users on each of the plurality of experimental versions of the webpage.

4. The system (200) as claimed in claim 1, wherein the interactions comprise clicking on areas of interest on a webpage, adding items of interest to a cart while browsing a webpage, downloading information/data from a webpage, clicking on links provided on a webpage, making payments, searching information on a webpage, or doing any other action on a webpage.

5. The system (200) as claimed in claim 1, wherein the gain comparison unit (222) sends each of the plurality of experimental versions of the webpage and each of the plurality of control versions of the webpage to the data tracker unit (208) for which the calculated gain difference is more than the predefined threshold.

6. A method (300) for correcting overlapping issues in A/B testing experiments, the method (300) comprising:
S1: receiving, by a data receiving unit (202), a plurality of control versions of a webpage and a plurality of experimental versions of the webpage;
S2: allocating, by a user allocation unit (204), users into a plurality of control groups and a plurality of experiment groups;
S3: allocating, by a data allocation unit (206), the plurality of control versions of the webpage to the plurality of control groups and the plurality of experimental versions of the webpage to the plurality of experimental groups, wherein one experimental version of the webpage is allocated to one respective experimental and one control version of the webpage is allocated to one respective control group;
S4: capturing, by a data tracker unit (208), relevant data points from each of the plurality of experimental versions of the webpage and each of the control versions of the webpage;
S5: identifying, by the data tracker unit (208), identity of users accessing each of the plurality of experimental versions of the webpage and each of the plurality of control versions of the webpage;
S6: identifying, by the data tracker unit (208), number of users carrying out an interaction in each of the plurality of experimental versions of the webpage and each of the plurality of control versions of the webpage;
S7: calculating, by the data tracker unit (208), a first number of interactions carried out by each of the plurality of experiment groups and each of the plurality of control groups based on the interactions carried out by the users identified for each of the plurality of experiment groups and each of the plurality of control groups;
S8: calculating, by a first experiment gain calculator unit (210), a first experiment gain for each of the plurality of experimental versions of the webpage based on the number of users identified for carrying out an interaction in the each of the plurality of experimental versions of the webpage;
S9: identifying, by an experiment overlap calculator unit (212), users common in the plurality of experiment groups and the plurality of control groups and to calculate interactions carried out by the identified common users in each of the plurality of experiment groups and each of the plurality of control groups to generate overlapping experiment groups and experiment groups overlapping with the control groups;
S10: calculating, by an additional interaction estimator unit (214), additional number of interactions carried out by each of the identified common users using gain data from the overlapping experiment groups and experiment groups overlapping with the control groups;
S11: obtaining, by an interaction data updater unit (216), modified number of interactions by subtracting the additional number of interactions from the first number of interactions calculated for each of the plurality of experimental versions of the webpage and each of the plurality of control versions of the webpage;
S12: calculating, by a second experiment gain calculator unit (218), a second experiment gain for each of the plurality of experimental versions of the webpage using the modified number of interactions;
S13: calculating, by a gain difference calculator unit (220), difference between the first gain and the second gain;
S14: comparing, by a gain comparison unit (222), the calculated gain difference with a predefined threshold;
S15: repeating steps S4-S14 when the calculated gain difference is more than the predefined threshold; and
S16: recording, by a final experiment gain calculator unit (224), a final gain for each of the plurality of experimental versions of the webpage when the calculated gain difference is less than the predefined threshold.

7. The method (300) as claimed in claim 6, wherein the plurality of control versions of the webpage comprise original versions of the webpage and the plurality of experimental versions of the webpage comprise a change in the webpage compared to the original version of the webpage.

8. The method (300) as claimed in claim 6, wherein the relevant data points comprise actions performed by users on each of the plurality of experimental versions of the webpage.

9. The method (300) as claimed in claim 6, wherein the interactions comprise clicking on areas of interest on a webpage, adding items of interest to a cart while browsing a webpage, downloading information/data from a webpage, clicking on links provided on a webpage, making payments, searching information on a webpage, or doing any other action on a webpage.
